(19) United States
(12) Patent Application Publication
(10) Pub. No.: US 2024/0123644 A1
(43) Pub. Date: Apr. 18, 2024

(54) COLLAPSIBLE HAND TOOLS

(71) Applicant: GB II Corporation dba Columbia River Knife & Tool Company, Tualatin, OR (US)

(72) Inventor: Joseph Caswell, Newbury Park, CA (US)

(73) Assignee: GB II Corporation dba Columbia River Knife & Tool Company, Tualatin, OR (US)

(21) Appl. No.: 18/484,126

(22) Filed: Oct. 10, 2023

Related U.S. Application Data
(60) Provisional application No. 63/416,201, filed on Oct. 14, 2022.

(51) Int. Cl. B26B 23/00

(52) U.S. Cl. CPC B26B 23/00; B25F 1/04

(57) ABSTRACT

A collapsible hand tool includes a first handle portion, a second handle portion, a first tool element, and a second tool element. The first handle portion and the second handle portion are rotatably coupled by a first pivot element. The first handle portion and the first tool element are rotatably coupled by a second pivot element. The second handle portion and the second tool element are rotatably coupled by a third pivot element. The first tool element and the second tool element are rotatably coupled by a fourth pivot element. The collapsible hand tool can be moved from a collapsed configuration to an open configuration, and from the open configuration to the collapsed configuration.

### CROSS REFERENCE TO RELATED APPLICATION

The present application claims the benefit of U.S. Provisional Application No. 63/416,201, filed Oct. 14, 2022, which in incorporated herein by reference in its entirety.

### FIELD

The present disclosure relates to collapsible hand tools and spring clips for collapsible hand tools.

### BACKGROUND

Foldable hand tools that have one or more tool elements that can be folded between a stored position and an open position are well known. A folding knife, for instance, includes a handle and a blade that can be pivoted 180 degrees between a stored position at least partially within the handle and an open position extending from the handle.

### SUMMARY

The present disclosure pertains to a collapsible or foldable hand tool that can include two tool elements that can be folded between a compact, stored position and an open position for use in which both tool elements are deployed and extend in opposite directions from the same end of the handle and generally perpendicular to the length of the handle. For example, the collapsible hand tool can be a collapsible axe in which one of the tool elements is an axe head and the other tool element can be a spike or claw.

In one representative embodiment, a hand tool comprises a first handle portion comprising a first end portion and a second end portion; a second handle portion comprising a first end portion and a second end portion; a first tool element; and a second tool element; wherein the first end portion of the first handle portion is rotatably coupled to the first end portion of the second handle portion at a first pivot axis; wherein the second end portion of the first handle portion is rotatably coupled to the first tool element at a second pivot axis; wherein the second end portion of the second handle portion is rotatably coupled to the second tool element at a third pivot axis; and wherein the first tool element is rotatably coupled to the second tool element at a fourth pivot axis; wherein the hand tool is movable from a closed configuration to an open configuration.

In another representative embodiment, a hand tool comprises first and second handle portions rotatably coupled to each other at a first pivot axis; a first tool element rotatably coupled to the first handle portion at a second pivot axis; a second tool element rotatably coupled to the second handle portion at a third pivot axis; wherein the first and second tool elements are rotatably coupled to each other at a fourth pivot axis; and wherein the hand tool is configured to transition from a storage position to a use position by rotating the first and second handle portions relative to each other about the first pivot axis, rotating the first tool element relative to the first handle portion about the second pivot axis, rotating the second tool element relative to the second handle portion about the third pivot axis, and rotating the first and second tool elements relative to each other about the fourth pivot axis.

In another representative embodiment, a hand tool comprises a handle having a recess and a ledge extending within the recess; a spring clip disposed in the recess and comprising a first end portion, a second end portion, a first leg, and a second leg joined to the first leg at the first end portion of the spring clip, the first leg and the second leg defining an opening; wherein the ledge extends into the opening between the first leg and the second leg; wherein pressing on the first end portion of the spring clip causes the opening between the first leg and the second leg to widen at the second end portion to move the spring clip from a non-deflected state to a deflected state; and wherein when the spring clip is in the non-deflected state, the first leg and the second leg do not extend outside of the recess.

The foregoing and other objects, features, and advantages of the invention will become more apparent from the following detailed description, which proceeds with reference to the accompanying figures.

### BRIEF DESCRIPTION OF THE DRAWINGS

FIG. 1 is a first side view of a collapsible hand tool according to one example.

FIG. 2 is a second side view of the collapsible hand tool of FIG. 1.

FIG. 3 is a bottom view of the collapsible hand tool of FIG. 1.

FIG. 4 is a top view of the collapsible hand tool of FIG. 1.

FIG. 5 is a perspective view of the collapsible hand tool of FIG. 1 in an open configuration.

FIG. 6 is another perspective view of the collapsible hand tool of FIG. 1 in an open configuration.

FIG. 7 is a first side view of the collapsible hand tool of FIG. 1 in a partially deployed configuration.

FIG. 8. is a second side view of the collapsible hand tool of FIG. 1 in a partially deployed configuration.

FIG. 9 is a first side view of the collapsible hand tool of FIG. 1 in a closed configuration.

FIG. 10 is a second side view of the collapsible hand tool of FIG. 1 in a closed configuration.

FIG. 11 is a perspective view of the collapsible hand tool of FIG. 9.

FIG. 12 is a first enlarged perspective view of the head portion of the collapsible hand tool of FIG. 1 shown in a partially deployed configuration.

FIG. 13 is a second enlarged perspective view of the head portion of the collapsible hand tool of FIG. 1 shown in a partially deployed configuration.

FIG. 14 is an exploded view of the collapsible hand tool of FIG. 1.

FIG. 15 is an exploded view of the head portion of the collapsible hand tool of FIG. 1.

FIG. 16 is a perspective view of a handle portion of a collapsible hand tool according to one example having a deflecting spring clip.

FIG. 17A is a side view of the handle portion of FIG. 16 showing the spring clip in a flush state.

FIG. 17B is a side view of the handle portion of FIG. 16 showing the spring clip in a deflected state.

FIG. 17C is a side view of the handle portion of FIG. 16 showing the spring clip receiving an edge portion of a garment.

FIG. 18 is a first side view of a collapsible hand tool in a deployed configuration according to another example.

FIG. 19 is a second side view of the collapsible hand tool of FIG. 18 in a deployed configuration.

FIG. 20A is the first side view of the collapsible hand tool of FIG. 18 in a storage configuration with a handle latch mechanism in an unlocked position.

FIG. 20B is the first side view of the collapsible hand tool of FIG. 18 in a storage configuration with the latch mechanism a locked position.

FIG. 21 is a second side view of the collapsible hand tool of FIG. 18 in a storage configuration.

FIG. 22A is an exploded, enlarged view of a portion of the collapsible hand tool of FIG. 18 showing components of the handle latch mechanism.

FIG. 22B is a schematic side view of the latch arm of the latch mechanism.

FIG. 23 is an enlarged view of a handle portion of the collapsible hand tool of FIG. 18.

FIG. 24 is an enlarged view of an opposing handle portion of the collapsible hand tool of FIG. 18.

FIG. 25 is an enlarged, exploded view of a head portion of the collapsible hand tool of FIG. 18 showing another example of a locking mechanism.

FIG. 26 is another exploded view of the head portion of the collapsible hand tool of FIG. 18.

FIG. 27 is an enlarged, perspective view of a locking bar of the locking mechanism of the collapsible hand tool of FIG. 18.

FIG. 28 is an exploded perspective view of the collapsible hand tool of FIG. 18.

### DETAILED DESCRIPTION

Collapsible hand tools disclosed herein can be deployed from a closed (stored) configuration to an open (use) configuration. Thus, the collapsible hand tools can be stored or carried in a compact, collapsed form and deployed from the collapsed state to the open configuration for use. The collapsible hand tools can also be returned to the collapsed state when no longer in use for ease of storage and carrying.

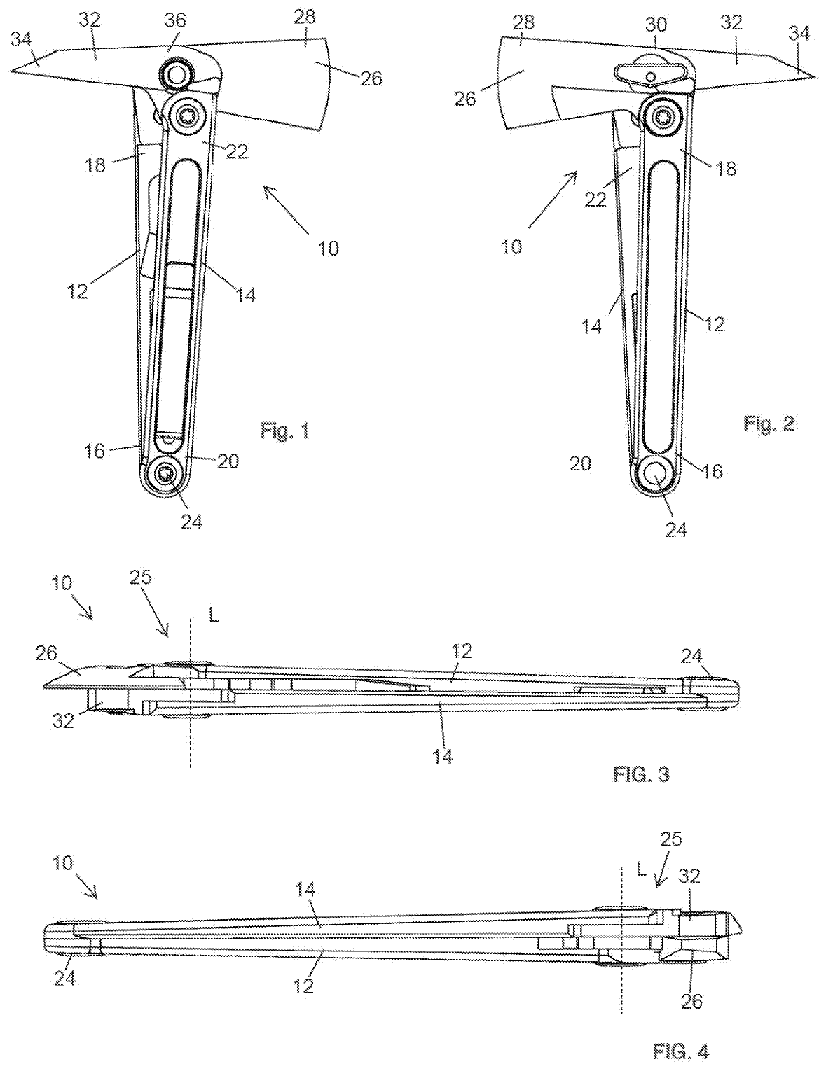

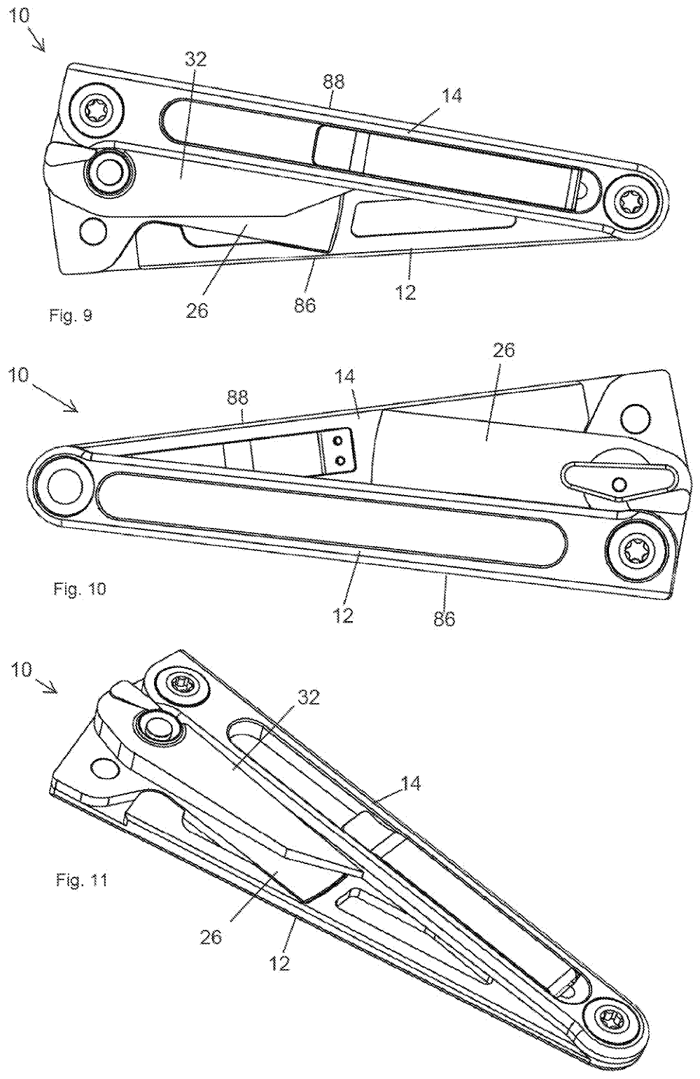

FIGS. 1 and 2 show a collapsible hand tool 10 according to one example in front and back views, respectively. The collapsible hand tool 10 can be moved between a closed configuration (illustrated in FIGS. 9-11 and discussed in greater detail herein) and an open configuration such as that shown in FIGS. 1-2. This enables the collapsible hand tool 10 to be stored and carried in the closed configuration and deployed to the open configuration for use. Thereafter, the collapsible hand tool 10 can be returned to the closed configuration for further storage and carrying.

As shown in FIG. 1, the collapsible hand tool 10 comprises a first handle portion 12, and a second handle portion 14. The first handle portion 12 has a first end portion 16 and a second end portion 18. The second handle portion 14 comprises a first end portion 20 and a second end portion 22, and can extend at an angle A (shown in FIG. 7) relative to the first handle portion 12. A first pivot element 24 rotatably couples the first end portion 16 of the first handle portion 12 to the first end portion 20 of the second handle portion 14, as shown in FIG. 1. This enables the angle A between the first handle portion 12 and the second handle portion 14 to change as the handle portions 12, 14 are rotated relative to one another to move the collapsible hand tool 10 from the open configuration to the closed configuration or from the closed configuration to the open configuration.

The collapsible hand tool 10 also comprises a first tool element 26. The first tool element 26 has a first tool end portion 28 and a second tool end portion 30. The first tool end portion 28 can comprise an operational tool end. In some examples, such as that illustrated in FIGS. 1-2, the collapsible hand tool 10 is a collapsible axe, the first tool element 26 is an axe head, the first tool end portion 28 is the blade portion of the axe head, and the second tool end portion 30 is the tang portion of the axe head. In some examples, the first tool element 26 can have a variable thickness that is thinner towards the first tool end portion 28 (that is, towards the blade portion of the axe head) and thicker towards the second tool end portion 30 (that is towards the tang portion of the axe head). Likewise, the first tool element 26 can be broader towards the first tool end portion 28 to provide an edge or blade, and narrower towards the second tool end portion 30.

The collapsible hand tool 10 also comprises a second tool element 32, as shown in FIGS. 1-2. The second tool element 32 can have a third tool end portion 34 and a fourth tool end portion 36. In some examples, such as when the collapsible hand tool 10 is a collapsible axe as shown in FIGS. 1-2, the second tool element 32 can be a spike or a claw. In such examples, the second tool element 32 can have a variable thickness that is thinner towards the third tool end portion 34 (that is towards the spike or claw of the second tool element 32) and thicker towards the fourth tool end portion 36 (that is, towards the tang portion of the second tool element 32). Likewise, the second tool element 32 can be narrower towards the third tool end portion 34 and broader towards the fourth tool end portion 36 to provide a spike, claw, or other penetrating device for the collapsible hand tool 10. In some examples, the second tool element 32 can alternatively be configured to provide a blunt impact surface along the third tool end portion 34, such as in the form of a rounded or flattened surface, similar to a tomahawk. In some examples, the second tool element 32 can be relatively short and comprise a blunt impact surface at the third tool end portion 34 to provide a hatchet configuration for the collapsible hand tool 10.

In some examples, the second tool element 32 need not be functional as a tool, but still serves as a linkage between the second handle portion 14 and the first tool element 26 to facilitate opening and closing of the hand tool 10, as described in detail below. In such examples, the second tool element 32 may be referred to as a linkage member or a pivot arm. Thus, in such examples, the hand tool 10 may have only one functional tool element 26.

As shown in greater detail in FIG. 15, which depicts the first tool element 26 and the second tool element 32 in closer view, the first tool element 26 can comprise a first tang projection 44 and the second tool element 32 can comprise a second tang projection 46. The first tang projection 44 can extend from the second tool end portion 30, and the second tang projection 46 can extend from the fourth tool end portion 36. The tang projections 44, 46 can have a smaller thickness than the tool end portions 30, 36 from which they extend.

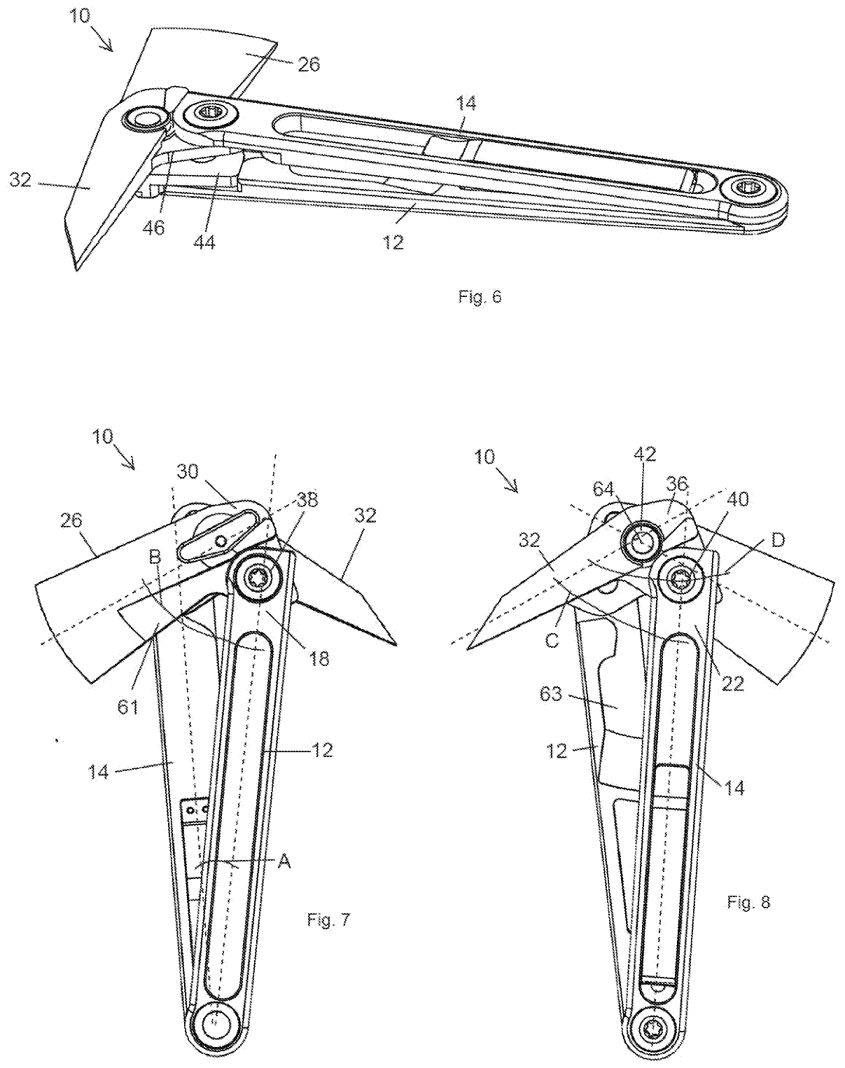

As shown in FIGS. 5 and 6, the first handle portion 12 and the second handle portion 14 can be arranged opposing one another to form a handle for the collapsible hand tool. Portions of first tool element 26 and the second tool element 32 are disposed between the first handle portion 12 and the second handle portion 14. More particularly, as shown in FIG. 6, the tang projections 44, 46 of the first tool element 26 and the second tool element 32 can extend between the first and second handle portions 12, 14 of the collapsible hand tool 10. In this way, the tool elements 26, 32 can be retained between the handle portions 12, 14.

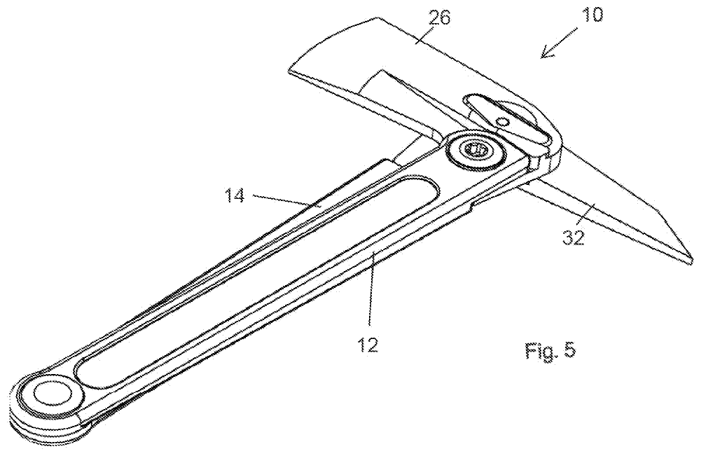

As shown in FIGS. 3 and 4, the first handle portion 12, the second handle portion 14, the first tool element 26, and the second tool element 32 can be layered or interleaved alongside one another. For example, as illustrated, a line L drawn through a head portion 25 of the collapsible hand tool 10 will extend through the first handle portion 12, the first tool element 26, the second tool element 32, and the second handle portion 14, with the first handle portion 12 and the second handle portion 14 disposed on opposite sides of the tool elements 26, 32.

Turning now to FIG. 7, the first tool element 26 can be rotatably coupled to the first handle portion 12 by a second pivot element 38. As illustrated, the second pivot element 38 can extend laterally through both the second end portion 18 of the first handle portion 12, and through the second tool end portion 30. The second pivot element 38 can allow the first tool element 26 and the first handle portion 12 to rotate relative to each other as the collapsible hand tool is moved from the closed configuration to the open configuration or vice versa. This enables the angle B between the first handle portion 12 and the first tool element 26 to change as the collapsible hand tool 10 is deployed from or returned to the closed configuration. In some examples, an angle B can be 0 degrees or approximately 0 degrees (that is, the first tool element 26 and the first handle portion 12 can be substantially parallel) when the collapsible hand tool 10 is in the closed configuration and can be 90 degrees or approximately 90 degrees (that is, the first tool element 26 and the first handle portion 12 can be substantially perpendicular) when the collapsible hand tool is in the open configuration. It is to be appreciated, however, that in other examples, the closed and open configurations can correspond to different values of the angle B between the first tool element 26 and the first handle portion 12.

Similarly, as shown in FIG. 8, the second tool element 32 can be rotatably coupled to the second handle portion 14 by a third pivot element 40. As illustrated, the third pivot element 40 can extend laterally through both the second end portion 22 of the second handle portion 14, and through the fourth tool end portion 36. The third pivot element 40 can allow the second tool element 32 and the second handle portion 14 to rotate relative to each other as the collapsible hand tool 10 is moved from the closed configuration to the open configuration or vice versa. This enables an angle C between the second handle portion 14 and the second tool element 32 to change as the collapsible hand tool 10 is deployed from or returned to the closed configuration. In some examples, the angle C can be 0 degrees or approximately 0 degrees (that is, the second tool element 32 and the second handle portion 14 can be substantially parallel) when the collapsible hand tool 10 is in the closed configuration and can be 90 degrees or approximately 90 degrees (that is, the second tool element 32 and the second handle portion 14 can be substantially perpendicular) when the collapsible hand tool is in the open configuration. It is to be appreciated, however, that in other examples, the closed and open configurations can correspond to different values of the angle C between the second tool element 32 and the second handle portion 14.

With continued reference to FIG. 8, the first tool element 26 and the second tool element 32 can be connected to each other by a fourth pivot element 42. As illustrated, the fourth pivot element 42 can extend laterally through the first tool element 26 and the second tool element 32 at the second tool end portion 30 and the fourth tool end portion 36. The fourth pivot element 42 can allow the first tool element 26 and the second tool element 32 to rotate relative to each other as the collapsible hand tool 10 is moved from the closed configuration to the open configuration or vice versa. This enables an angle D between a centerline of the first tool element 26 and a centerline of the second tool element 32 to change as the collapsible hand tool 10 is deployed from or returned to the closed configuration. In some examples, the angle D can be 0 degrees or approximately 0 degrees when the collapsible hand tool 10 is in the closed configuration and can be 180 degrees or approximately 180 degrees when the collapsible hand tool 10 is in the open configuration.

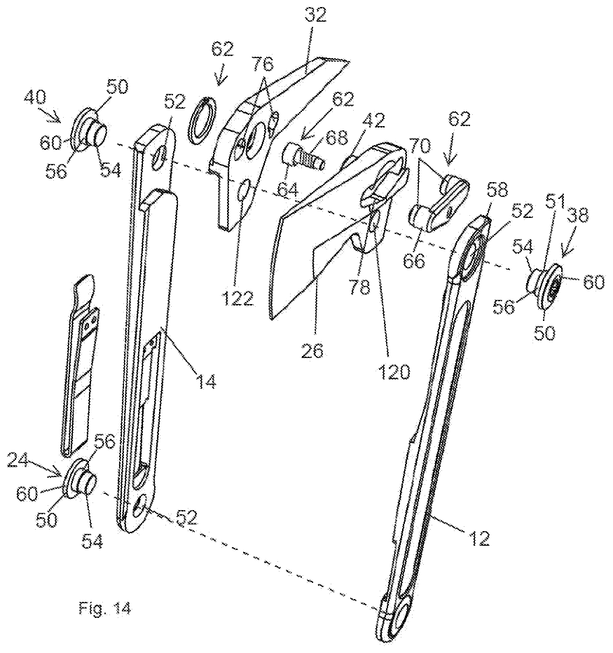

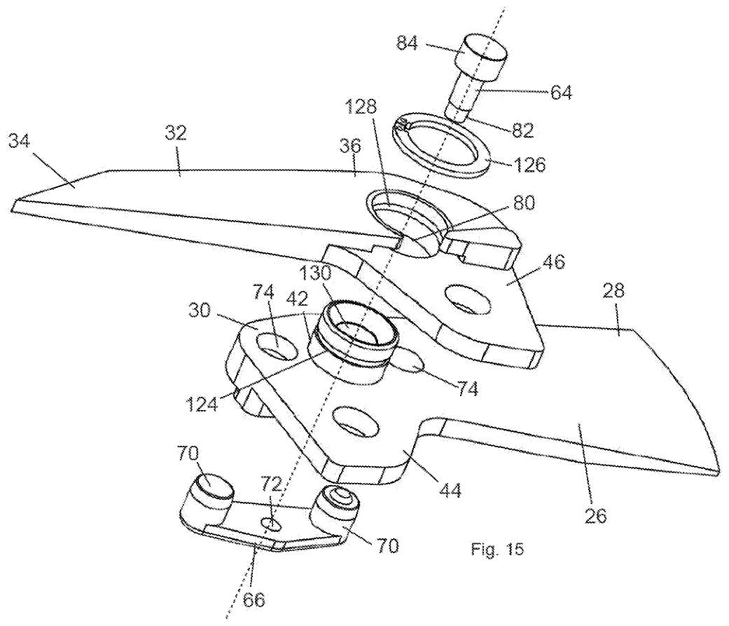

In some examples, some or all the pivot elements 24, 38, 40, and 42 can be shoulder screws. For instance, as illustrated in FIG. 14, the pivot elements 24, 38, and 40 can each comprise a shoulder screw 50 that extends through a pivot aperture 52. The screw 50 comprises a shaft portion 51 extending from a head portion 60. The shaft portion 51 comprises a threaded element 54 and a shoulder element 56, which may be non-threaded in some examples and has a larger diameter than the threaded element. In other examples, the shoulder element 56 can be threaded. The threaded element 54 engages and is tightened in a corresponding threaded bore, leaving the shoulder element 56 in the pivot aperture 52.

For example, the shaft portion 51 of the pivot element 38 extends through an aperture 52 of the first handle portion and its threaded element can be tightened into a corresponding threaded bore 120 in the first tool element 26. Similarly, the shaft portion 51 of the pivot element 40 can extend through an aperture 52 of the second handle portion 14 and its threaded element 54 can be tightened into a corresponding threaded bore 122 of the second tool element 32. The shaft portion 51 of the pivot element 24 can extend through an aperture 52 in the second handle portion 14 and its threaded element 54 can be tightened into a corresponding threaded bore of the first handle portion 12. In some examples, alternative fastening means may also be utilized.

In some examples, the handle portions 12, 14 can also comprise one or more pivot recesses 58 circumscribing respective apertures 52. The pivot recesses 58 can receive a head portion 60 of a corresponding screw 50 of one of the pivot elements 24, 38, 40, 42, such that the screw 50 of the respective pivot element will be flush with the handle portion 12, 14 through which it extends. In this way, the pivot elements do not add to the thickness of the collapsible hand tool 10. It is to be understood, however, that in some examples, the pivot elements may not be flush with the handle portions 12, 14 through which they extend. It is also to be understood that, in some examples, other types of pivot elements or mechanisms can be used in lieu of or in addition to pivot elements 24, 38, 40, 42 to rotatably coupled the handle portions 12, 14 to each other or to the tool elements 26 and 32, such pivot mechanisms that comprise bearings. In some examples, one or more of the pivot elements 24, 38, 40, 42 can comprise a male component (such as a screw or pin) that extends into or is tightened into a separate female component (such as a sleeve with a threaded bore).

As best shown in FIG. 15, the fourth pivot element 42 can comprise a post that is fixedly secured to a side of the tang of the first tool element 26 and extends laterally through an opening 80 in the tang of the second tool element 32. The outer surface of the pivot element 42 can include a circumferentially extending groove 124 that at least partially receives a retainer ring 126 (known as a “snap ring”). The inner surface of the opening 80 can be formed with a corresponding circumferentially extending groove 128 that faces the groove 124 of the pivot element 42. When fully assembled, the retaining ring 126 is partially received within the groove 124 and the groove 128 to retain the pivot element 42 within the opening 80 while allowing the second tool element 32 to rotate relative to the pivot element 42 and the first tool element 26. Alternatively, the post may be configured as a threaded fastener that has a threaded portion and head or flange connected to the threaded portion. The threaded portion can be tightened into a threaded aperture in the first tool element 26 and the head or flange portion can be positioned adjacent the outer side surface of the second tool element 32 to retain second tool element 32 on the post while allowing the second tool element to rotate relative to the post.

In some examples, one or both of the first handle portion 12 and the second handle portion 14 can comprise one or more recesses 63. For example, as shown in FIG. 8, the first handle portion 12 can comprise a recess 63 with a geometry configured to receive a portion of the first tool element 26, such as part of the first tool end portion 28 (that is, the axe head 28 in the illustrated example), when the collapsible hand tool 10 is in the closed configuration. In this way, a portion of the first tool element 26 can be positioned between the first handle portion 12 and the second handle portion 14 when the tool is in the closed configuration.

In some examples, one or more of the first tool element 26 and the second tool element 32 can also comprise one or more recesses 61. For example, as shown in FIG. 7, the first tool element 26 can comprise a recess 61, configured to receive part of the first end portion 16 of the first handle portion 12 when the collapsible hand tool 10 is in the closed configuration.

The collapsible hand tool 10 can also comprise a locking mechanism 62 configured to retain the collapsible hand tool 10 in the open configuration. In some examples, such as that illustrated in FIGS. 14 and 15, the locking mechanism 62 can comprise a bolt 64, a locking bar 66, and a spring element 68.

As shown in FIG. 15, the locking bar 66 can comprise one or more lock projections 70 and a bolt socket 72. The one or more lock projections 70 extend through one or more lock apertures 74 in one of the tool elements 26, 32 and can be configured to align with one or more corresponding sockets 76 (as illustrated in FIG. 14) in the other of the tool elements 26, 32 when the collapsible hand tool 10 is in the open configuration. In some examples, the locking bar 66 can be disposed within a recess 78 in one of the tool elements 26, 32 such that the locking bar 66 remains flush with the surface of the respective tool element.

For example, as illustrated in FIGS. 14 and 15, the locking bar 66 comprises two lock projections 70 extending through two lock apertures 74 in the first tool element 26 and configured to align with two corresponding sockets 76 in the second tool element 32 when the collapsible hand tool 10 is in the open configuration. The locking bar 66 can be disposed within a recess 78 in the first tool element 26, such that the locking bar 66 is flush with the surface of the first tool element 26.

As best shown in FIG. 15, the bolt 64 extends through a bore 130 in the pivot element 42 and through both the first tool element 26 and the second tool element 32. A threaded end portion 82 of the bolt 64 extends into the bolt socket 72 of the locking bar 66 and engages a corresponding inner thread in the bolt socket 72. A head portion 84 of the bolt 64 is disposed within the bore 130 or may protrude slightly laterally out of the bore 130. The spring element 68 is thus disposed between the head portion 84 of the bolt 64 and the first tool element 26.

When the collapsible hand tool 10 is in the open configuration, the lock projections 70 of the locking bar 66 align with the corresponding sockets 76 in the second tool element 32. The spring element 68 urges the bolt 64 laterally outwards relative to the second tool element 32, and the bolt 64 pulls the locking bar 66 laterally inwards toward the first tool element 26. This causes the lock projections 70 to engage the corresponding sockets 76 and prevents the first tool element 26 and the second tool element 32 to rotate relative to one another while the locking mechanism 62 is engaged, which retains the collapsible hand tool 10 in the open configuration. The locking mechanism is in a locked position when the lock projections 70 extend into the corresponding sockets 76.

To return the collapsible hand tool 10 to the closed configuration, the head portion 84 of the bolt 64 can be pressed laterally inwards toward the second tool element 32. This moves the locking bar 66 laterally outwards relative to the first tool element 26 and causes the lock projections 70 to exit the corresponding sockets 76, placing the locking mechanism in an unlocked position. Thereafter, the first tool element 26 and the second tool element 32 can be rotated relative to one another, and inwards relative to the handle portions 12, 14 to return the collapsible hand tool 10 to the closed configuration. In this manner, the bolt 64 functions as a push button or actuator for moving the locking mechanism from the locked position to the unlocked position.

While FIG. 14 depicts a locking mechanism 62 with the locking bar 66 positioned in a recess 78 in the first tool element 26, and with lock projections 70 extending into corresponding sockets 76 in the first tool element 26, it will be appreciated that, in some examples, the alignment of the locking element could be reversed. That is, the locking bar 66 could be disposed in a recess 78 in the second tool element 32 and the lock projections 70 could extend through the lock apertures 74 in the second tool element 32 and into corresponding sockets 76 in the first tool element 26.

The collapsible hand tool 10 can be carried or stored in a compact, closed configuration, and deployed for use from the closed configuration to the open configuration. FIGS. 9-11 depict the collapsible hand tool 10 in the closed configuration. In the closed configuration, the angle A between the first handle portion 12 and the second handle portion 14 is at a maximum value, and the tool elements 26, 32 are overlapped with the handle portions 12, 14 of the collapsible hand tool 10. Although not required, the tool elements 26, 36 desirably are sized and shaped relative to the handle portions 12, 14 such that no portion of either tool element 26, 32 extends past a first outer edge 86 or a second outer edge 88 of the handle portions 12, 14 in the closed configuration.

As illustrated in FIG. 10, when the collapsible hand tool 10 is in the closed configuration, the first tool element 26 extends parallel to or substantially parallel to the first handle portion 12, and at least a portion of the first tool element 26 is disposed between the first handle portion 12 and both the second handle portion 14 and the second tool element 32.

Similarly, as shown in FIG. 9, when the collapsible hand tool 10 is in the closed configuration, the second tool element 32 extends parallel to or substantially parallel to the second handle portion 14, with a portion of the first tool element 26 positioned between the second tool element 32 and the first handle portion 12.

In this way, as shown in FIG. 11, the tool elements 26, 32 are retained between the handle portions 12, 14 and extend alongside the handle portions 12, 14 when the collapsible hand tool 10 is in the closed configuration. In this way, the tool elements 26, 32 advantageously do not add to the overall thickness of the collapsible hand tool 10 when it is in the closed configuration.

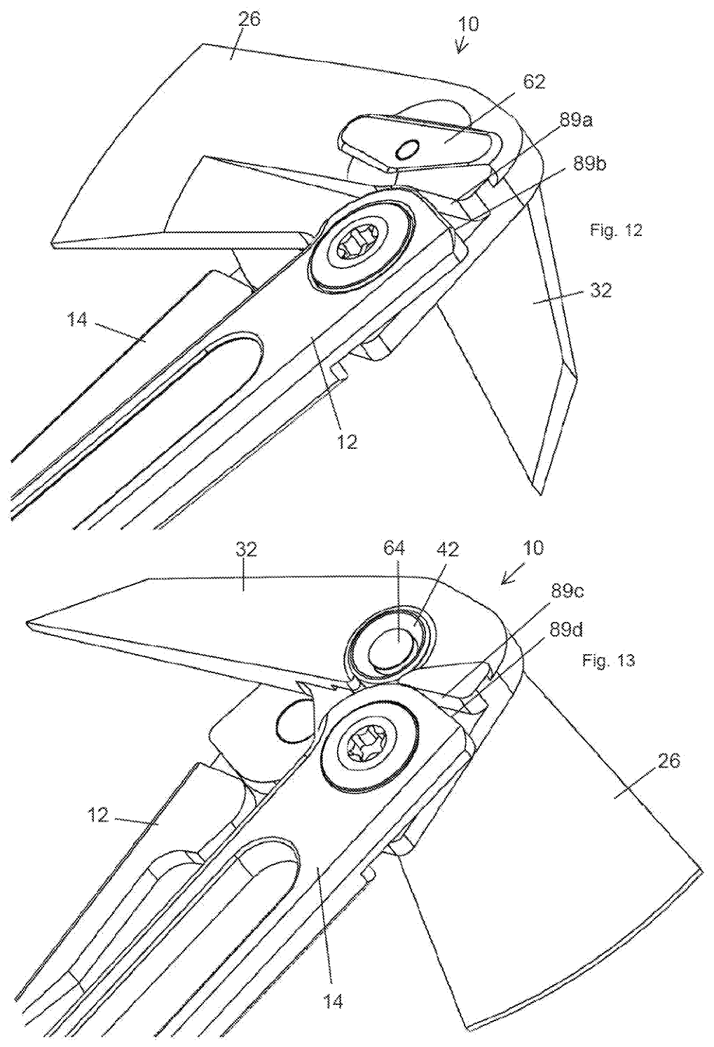

As the collapsible hand tool 10 is deployed from the closed configuration to the open configuration (as shown in FIG. 5), the first tool element 26 moves rotationally away from the first handle portion 12 and the second tool element 32 moves rotationally away from the second handle portion 14 as illustrated in FIGS. 12 and 13. Simultaneously, the first handle portion 12 and the second handle portion 14 initially rotate away from each other (increasing angle A) from the closed configuration to an intermediate state, and then move rotationally closer to each other from the intermediate state to the open configuration (decreasing angle A). In some examples, the angle A in the open configuration is less than the angle A in the closed configuration. Thus, the angle A decreases overall and the angles B, C, and D increase as the collapsible hand tool 10 is deployed from the closed configuration to the open configuration.

As shown in FIGS. 12 and 13, when the first tool element 26 rotates relative to the first handle portion 12, a first locking surface 89a on the first tool element 26 approaches a second locking surface 89b on the first handle portion 12. Similarly, a third locking surface 89c on the second tool element 32 approaches a fourth locking surface 89d on the second handle portion 14.

As the collapsible hand tool 10 reaches the open configuration, the first tool element 26 approaches or reaches a perpendicular orientation relative to the first handle portion 12 and the second tool element 32 approaches or reaches a perpendicular orientation relative to the second handle portion 14. The first and second locking surfaces 89a, 89b, limit the rotational movement of the first tool element 26 relative to the first handle portion 12 by coming in contact with each other when the collapsible hand tool 10 reaches the open configuration. Similarly, the third and fourth locking surfaces 89c, 89d limit the rotational movement of the second tool element 32 relative to the second handle portion 14 by coming in contact with each other when the collapsible hand tool 10 reaches the open configuration. When the collapsible hand tool 10 fully reaches the open configuration, the locking mechanism 62 can engage as described herein to avoid accidental closure of the collapsible hand tool 10.

To return the collapsible hand tool 10 to the closed configuration, the locking mechanism 62 can be disengaged as described herein, and the tool elements 26, 32 can be folded inwards relative to the handle portions 12, 14 until the collapsible hand tool 10 is in the closed configuration.

It is to be appreciated that, while the collapsible hand tool 10 can be a collapsible axe such as that depicted in the figures and disclosed herein, other configurations for the tool elements are possible. For instance, in some examples, both tool elements 26, 32 can be axe heads or both tool elements 26, 32 can be spike or claw. In other examples, one or both tool elements 23, 32 can be a knife blade, a pick, a hammer head, etc., or various combinations of an axe head, a spike, a claw, a knife blade, a pick, or a hammer head. the tool elements 26, 32 of the collapsible hand tool can be tool elements of other types of hand tools.

The tool 10 can be opened from the closed configuration in a variety of ways. For example, a user can pull or pivot one of the tool elements 26, 32 away from an adjacent handle portion to move it to the open configuration. Since the tool elements 26, 32 are linked to each other and to the handle portions 12, 14, manually pivoting one of the tool elements is effective to the move the other tool elements and the handle portions to the open configuration. Another technique for opening the tool 10 involves flicking the tool open without touching either tool element. This involves gently grasping the handle portions 12, 14 with a hand preferably near the pivot element 24 without squeezing the handle portions together in a manner that prevents their movement relative to each other. While holding the handle portions in one hand, the user can then “flick” or abruptly move the wrist in one direction (such as in a downward or upward direction). The action of the wrist movement causes the tool elements to quickly pivot away from the closed position to the open position under their own weight.

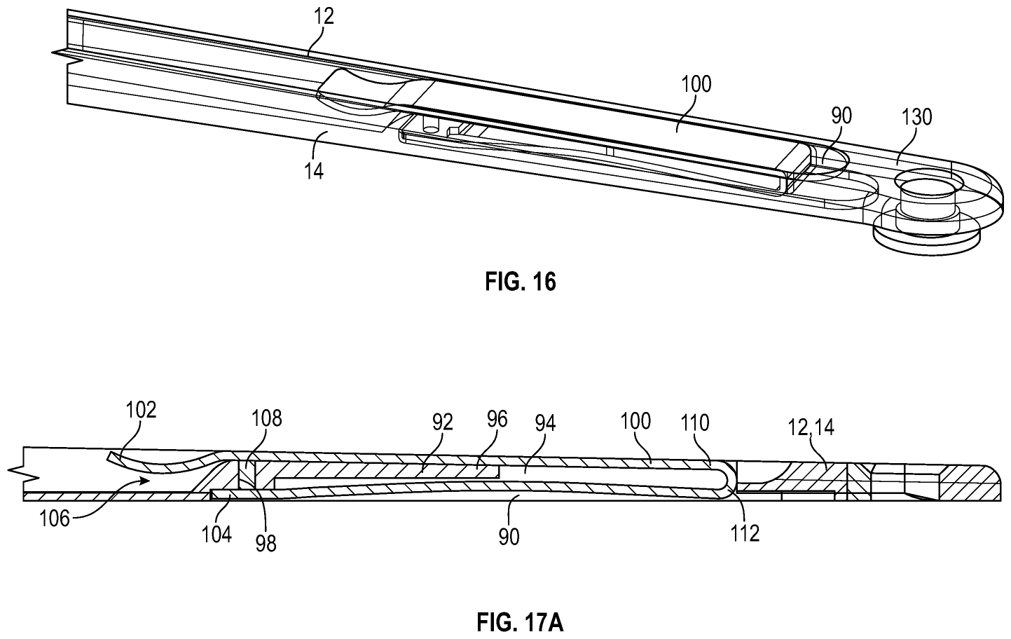

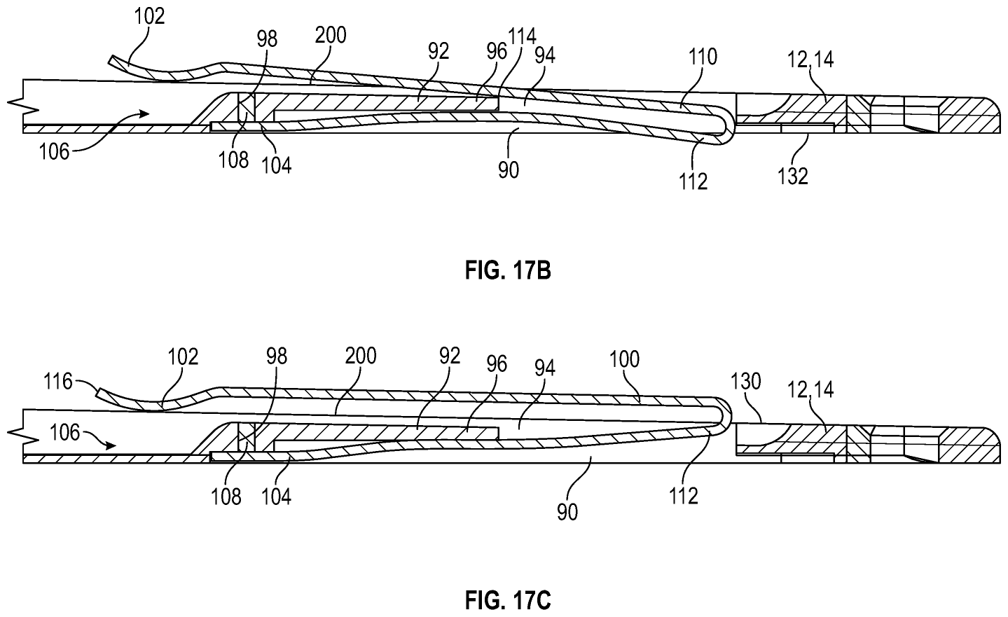

The collapsible hand tool 10 disclosed herein and illustrated in FIGS. 16-17C can further comprise a spring clip 100. The spring clip 100 can be configured to lie flush with or recessed within a handle portion 12, 14 of the collapsible hand tool 10 when not in use, so that the spring clip does not protrude laterally beyond the outer surface of the handle portion to which it is attached and therefore does not increase the overall thickness of the collapsible hand tool 10. By pressing on one end of the spring clip 100, a user can cause another end of the spring clip 100 to project past a handle portion 12, 14 of the collapsible hand tool 10 such that the spring clip 100 can receive an edge or portion of a garment.

As shown in FIG. 16, the spring clip 100 can be disposed in one of the handle portions 12, 14 of the collapsible hand tool 10 disclosed herein. As illustrated in FIGS. 17A-17C, the spring clip 100 comprises a first leg 102 and a second leg 104. The legs 102, 104 define a gap 106 between their free end portions that can be opened or closed by moving the legs 102, 104 further apart or closer together respectively. The legs 102, 104 can be joined at a first end portion 110 of the spring clip 100. In some examples, the first end portion 110 of the spring clip 100 comprises a u-shaped 180-degree bend 112, as shown in FIGS. 17A-17C, but it is to be understood that in some examples, the first end portion 110 can have different geometries, such as a square or angled geometry.

As shown in FIGS. 17A-17C, the spring clip 100 can be disposed in a recess 90 in the handle portion 12 or 14 of the collapsible hand tool. The handle portion 12 or 14 can further comprise a ledge 92 that extends axially across a portion of the recess 90, leaving a clip aperture or slot 94 between an end portion 96 of the ledge 92 and the handle portion 12 or 14.

The spring clip 100 can be attached to the handle portion 12 or 14 by inserting the ledge 92 into the gap 106 of the retention clip (or positioning one leg 102, 104 of the spring clip 100 on either side of the ledge 92). In some examples, the spring clip 100 can also comprise a projection 108, and the ledge 92 can comprise a socket 98 configured to receive the projection 108 to further secure the spring clip 100 to the handle portion 12, 14. In other examples, the spring clip can comprise a hole, and a screw can extend through the socket and the hole to secure the spring clip 100 to the handle portion 12, 14.

FIGS. 16 and 17A show the spring clip 100 in a non-deflected state wherein both the first leg portion 102 and the second leg portion 104 are positioned within the recess 90. In the non-deflected state, the legs 102, 104 do not extend past the outer side surface 130 of the handle portion 12 or 14 in which the recess 90 is formed. In some examples, this can be referred to as a “flush state” because the first leg portion 102 can be flush with the surface 130. In other examples, the first leg portion 102 can be recessed or spaced inwardly from the surface 130. Thus, the first leg 102 does not add to the thickness of the collapsible hand tool 10 and the second leg 104 does not impinge on the surface of the opposite handle portion.

FIG. 17B shows the spring clip 100 in a deflected state. The spring clip 100 can be moved from the non-deflected state to the deflected state by depressing the first end portion 110 laterally inwards from the handle portion 12 or 14 in which the recess 90 is formed and towards the opposite handle portion. This causes an intermediate portion 114 of the first leg portion 102 to pivot on an end portion 96 of the ledge 92 (which acts as a fulcrum for the movement of the spring clip 100). As the first end portion 110 is depressed, the first leg 102 extends laterally past the surface 130 of the handle portion 12 or 14 and the distance between the first leg 102 and the second leg 104 of the spring clip 100 increases, opening the gap 106 along a second end portion 116 of the spring clip 100. Because the first leg 102 extends past the surface 130 of the handle portion 12 or 14, a gap is also opened between the first leg 102 and the surface 130, allowing a portion of a garment 200 to be inserted between the leg portions 102, 104 so as to be retained between the first leg 102 and the handle portion 12 or 14. The garment portion 200 can be an edge portion of a pocket, a belt, a shirt, a pant, or any other garment to which a collapsible hand tool, such as collapsible hand tool 10 might be attached.

In some examples, the handle portion opposite to the handle portion 12 or 14 to which the clip 100 is attached can comprise a recess adjacent the first end portion 110 of the clip 100. The recess can receive the first end portion 110 of the spring clip 100 when the first end portion 110 is depressed to move the spring clip 100 from the non-deflected state to the deflected state. For example, if the clip 100 is attached to the first handle portion 12, the second handle portion 14 can include a recess formed along an inner surface thereof facing the first end portion 110 of the clip. When the clip is depressed inwardly (as shown in FIG. 17B), the first end portion 110 protrudes laterally beyond an inner surface 132 of the first handle portion 12 and is received in the recess of the second handle portion 14.

FIG. 17C shows the spring clip 100 with a garment edge portion 200 retained between the first leg 102 and the handle portion 12 or 14. As the garment edge portion 200 progresses into the gap 106 from the second end portion 116 towards the first end portion 110 of the spring clip 100 and manual pressure is released from the first end portion 110, depending on the thickness of the garment edge portion 200, the second leg 104 can be pulled laterally away from the opposing handle portion and into the recess 90 until it contacts the end portion 96 of the ledge 92, which acts as a fulcrum and allows the first end portion 110 of the spring clip 100 to pivot around the end portion 96 of the ledge 92 and out of the recess 90. The spring clip 100 resists the deformation caused by the introduction of the garment edge portion 200 with spring tension, which urges the exposed first leg 102 of the spring clip 100 back towards the handle portion 12 or 14, and secures the garment edge portion 200 between the spring clip 100 and the handle portion 12 or 14.

While FIG. 17B show a spring clip 100 with a first end portion 110 that extends past a handle portion 12 or 14 and into a recess in an opposite handle portion 12 or 14 when the first end portion 110 is deflected to open the gap 106, it is to be appreciated that a clip formed from a thinner sheet and/or using a longer section to the right of the fulcrum does not necessarily need to deflect into a recess or pocket on the opposite handle portion. Instead, a user pressing on the first end portion 110 of the spring clip 100 between the end portion 96 of the ledge 92 (that is the fulcrum) and the 180-degree bend 112 will flex the spring clip 100 to a lesser degree such that the first end portion 110 of the spring clip 100 does not extend out of the recess 90 into a corresponding recess in the opposite handle portion.

While the example of FIGS. 16-17C show a spring clip 100 attached to one of the handle portions 12, 14, in other examples, a spring clip 100 can be attached to each handle portion 12, 14 of the hand tool 10. In this manner, either side of the hand tool 10 can be used to attach the tool to a garment of the user.

The spring 100, the recess 90, and the ledge 92 can be implemented in various other types of hand tools, including but not limited to a folding knife or other types of foldable hand tools. A folding knife typically has two handle portions (sometimes referred to as “scales”) and a blade pivotably coupled to the handle portions. At least one of the handle portions can be formed with a recess 90 and can include a ledge 92 and a spring clip 100 disposed in the recess 90, in the same manner shown in FIGS. 16-17C.

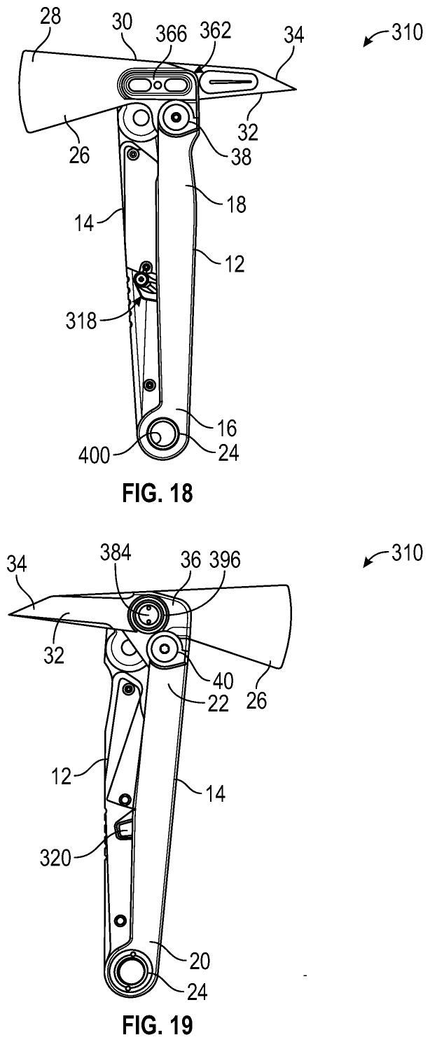

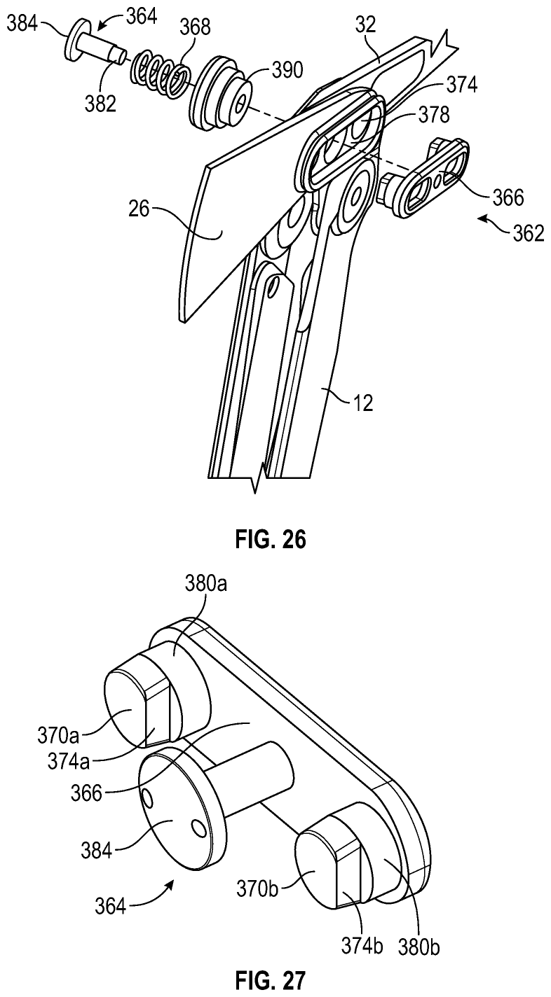

FIGS. 18-28 show another example of a collapsible hand tool 310 wherein the tool 310 comprises an alternative head locking mechanism 362 as well as an additional latch mechanism 318 as set forth in more detail below. The hand tool 10 and the hand tool 310 share many common components, which are given the same reference numbers and therefore are not described again below for the sake of brevity except for the purpose of disclosing certain differences between the hand tool 10 and the hand tool 310. Some of the common components in the hand tools 10, 310 may have small differences in overall shape, but it should be understood that unless certain differences are described below, the components in FIGS. 18-28 that have the same reference numbers as components in FIGS. 1-15 can have the same features and can function in the same way as previously described.

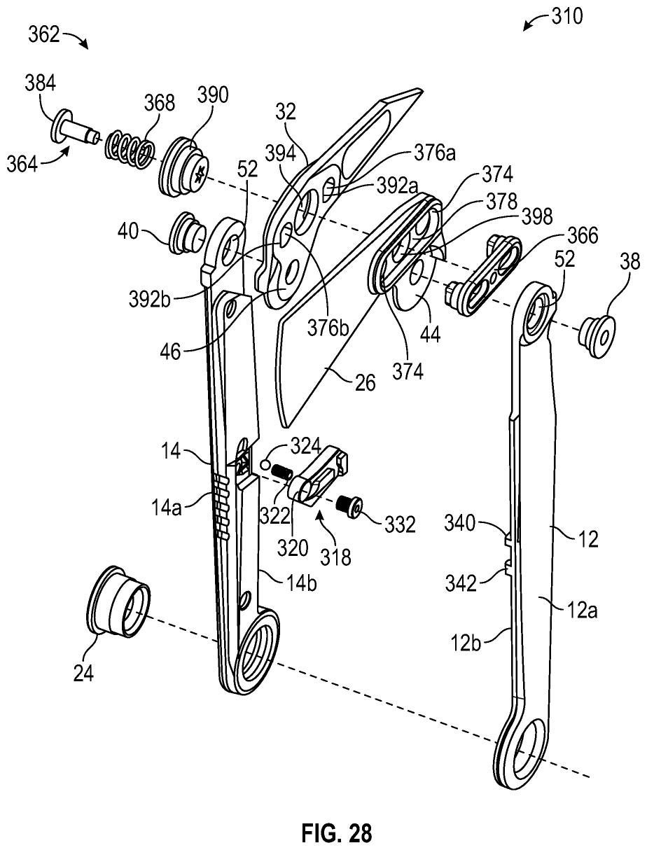

As best shown in FIG. 28, the first handle portion 12 can comprise an outer panel 12a (also referred to as “an outer scale”) and an inner panel 12b (also referred to as “an inner scale”) secured to the outer panel 12a. Similarly, the second handle portion 14 can comprise an outer panel 14a (or outer scale) and an inner panel 14b (of inner scale) secured to the outer panel 14a. In other examples, each of the first and second handle portions 12, 14 can be unitary structures, as the case for the hand tool 10.

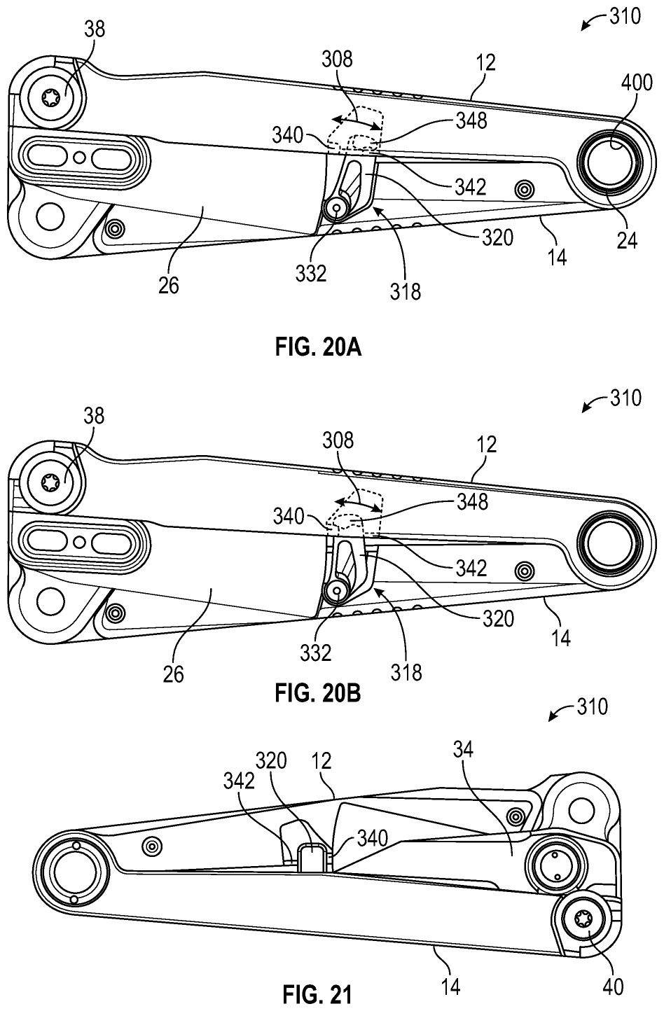

FIGS. 18 and 19 show the hand tool 310 in an open position ready for use. FIGS. 20A, 20B, and 21 show the hand tool 310 in a closed, storage position and illustrate the movement of the latch mechanism 318, which is configured to retain the hand tool 310 in the closed position by resisting movement of the first and second handle portions 12, 14 relative to each other. When engaged, the latch mechanism 318 prevents initial handle movement, maintaining the tool elements 26, 32 in the storage position. The latch mechanism 318 comprises a latch arm 320 that is pivotably coupled to the second handle portion 14 and can pivot between a locked position shown in FIGS. 20B and 21 and an unlocked position shown in FIG. 20A, in the directions indicated by double-headed arrow 308. When the latch arm 320 is in the locked position, the first and second handle portions 12, 14 are secured to each other, preventing tool deployment. When the latch arm 320 is in the unlocked position, the handle portions 12, 14 can move away from each other, thereby allowing the tool elements 26, 32 to move from the storage position to the open position.

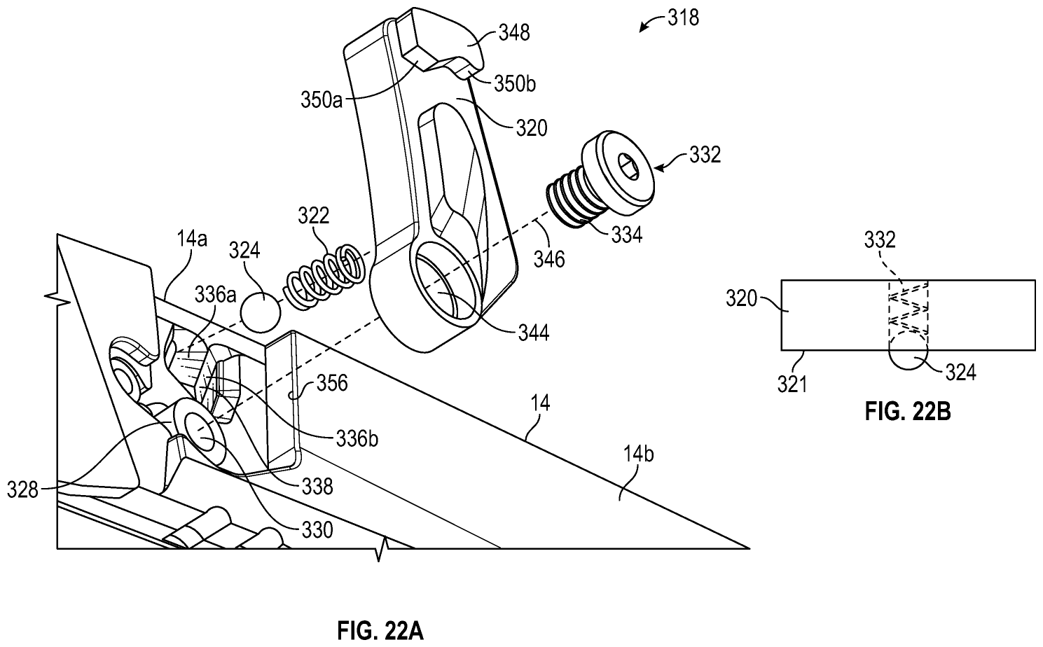

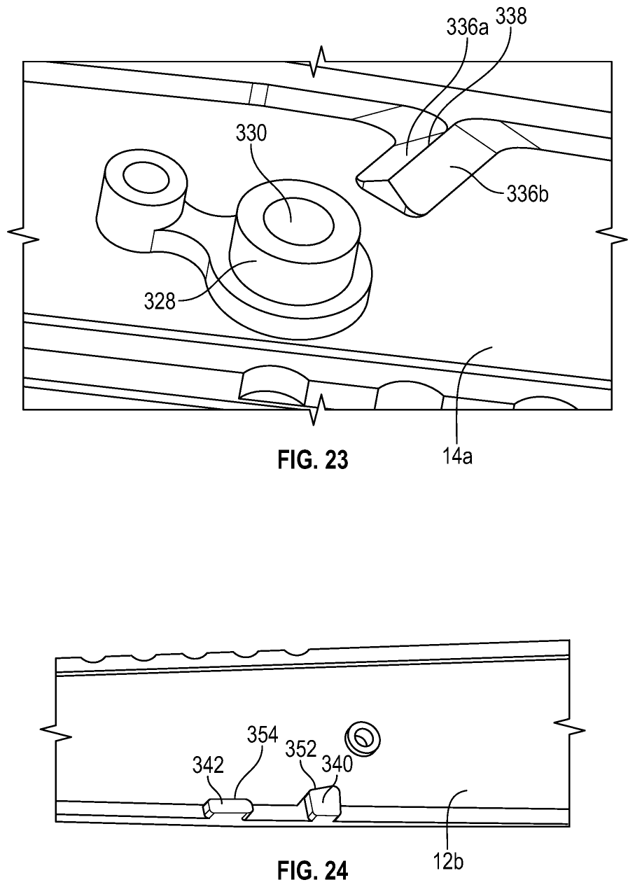

Turning to FIGS. 22A-24, in some examples, the latch mechanism 318 further comprises additional components to bias the latch arm 320 either into the locked position, wherein the latch arm 320 interfaces with or engages a first locking element of the first handle portion 12 in the form of a first protrusion or locking ledge 340, or the unlocked position, wherein the latch arm 320 interfaces with or engages a second protrusion or stop ledge 342 of the first handle portion 12. As shown in FIGS. 22A and 23, the latch arm 320 can be secured to a standoff 328 protruding from the outer panel 14a of the second handle portion 14 using a threaded fastener 332. The threaded fastener 332 extends through an aperture 344 in the latch arm 320 and a threaded end portion 334 of the fastener is received within an internally threaded hole 330 of the standoff 328. The latch arm 320 is thereby secured in pivoting relation about aperture 344 and permitted to rotate about a fastener axis 346 in the directions of arrow 308 shown in FIGS. 20A and 20B. As best shown in FIG. 24, the first and second protrusions 340, 342 can be formed on an inner surface of the inner panel 12b.

In addition to the latch arm 320, FIGS. 22A and 22B further show the latching mechanism 318 can further comprise a spring 322 and a ball 324 disposed in a bore formed in the latch arm 320. The spring 322 is captured between the ball 324 and an adjacent inner surface of the latch arm 320 such that the spring 322 biases the ball 324 toward the outer panel 14a of the second handle portion 14. Absent any external force applied to the ball 324 (except for the biasing force of the spring 322), a portion of the ball 324 can protrude slightly from an outer side surface 321 of the latch arm 320, but is otherwise retained partially inside bore so that it does not fall out of the bore. During operation of the latch arm, the ball 324 can slide further into the bore to compress the spring 332 and then back outwardly under the force of the spring 332.

As shown in FIG. 22A and FIG. 23, the outer panel 14a can be formed with two sloped detent surfaces 336a and 336b adjacent the latch arm 320. The detent surfaces 336a and 336b meet at a ridge or apex 338 so as to define a wedge that tapers in a direction from the outer panel 14a to the latch arm 320. The inner panel 14b can be formed with a notch or cutout 356 that is sized to receive the latch arm 320 and allows the ball 324 to contact the detent surfaces 336a, 336b, as further described below. During operation of the latching mechanism 318, the latch arm 320 can pivot within the notch 356 between the locked and unlocked position.

When the latch arm 320 is in the unlocked position of FIG. 20A, the ball 324 is biased against the bottom or lower side of the detent surface 336b. When the user wishes to move the latch arm 320 into the locked position, the latch arm 320 is rotated about axis 346 toward the first protrusion 340 (counter-clockwise in FIG. 20A). As the latch arm is rotated, the ball 324 slides up along the detent surface of 336b from the lower side toward the ridge 338, all the while increasing the compression of spring 322. When the ball 324 moves past the ridge 338 and onto the detent surface 336a, the compressed spring facilitates movement of the ball downward along the detent surface 336a, urging the ball into position at the bottom of detent surface 336a and urging the latch arm 320 into the locked position. In this manner, the latch arm 320 becomes biased into the locked position when it is rotated past the ridge 338 toward the detent surface 336a. Thus, the latch arm 320 is biased toward the locked position when the latch arm is juxtaposed to or overlapping the detent surface 336a.

Conversely, when the user wishes to then move the latch arm 320 into the unlocked position, the latch arm 320 is rotated about axis 346 toward the second protrusion 342 (clockwise in FIG. 20A), which causes the ball 324 to slide up along the detent surface 336a toward ridge 338, once again compressing spring 322. Once the latch arm and ball are pushed past ridge 338, the spring urges the ball along the detent surface 336b and latch arm into the unlocked position. In this manner, the latch arm 320 becomes biased in the unlocked position when it is rotated past the ridge 338 toward the detent surface 336b. Thus, the latch arm 320 is biased toward the unlocked position when the latch arm is juxtaposed to or overlapping the detent surface 336b. The spring therefore biases the ball and the latch arm to either one of the lower sides of the detent surfaces 336a and 336b, ensuring that the latch arm resides in either an engaged (locked) position or a disengaged (unlocked) position.

Once the latch arm 320 is biased into the locked position, an interfacing protrusion 348 on the end of the latch arm secures the latch arm in the locked position. In particular, when the latch arm is pivoted into the locked position of FIGS. 20B and 21, an interfacing surface 350a of the protrusion 348 on the latch arm 320 engages a corresponding surface 352 of the first protrusion 340 on the first handle portion 12, thus resisting the initial movement of the handle portions 12, 14 that deploys the tool elements 26, 32, and thereby keeping the tool elements in a storage position while the latch arm is maintained in the locked position.

FIG. 20A conversely shows a configuration wherein the latch arm 320 is rotated away from the first protrusion 340 and an interfacing surface 350b of the interfacing protrusion 348 of the latch arm 320 engages the second protrusion 342 of the first handle portion 12 (in other words, the latch arm is in the unlocked position). In some examples, the interfacing surface 350b and the second protrusion 342 are sized and shaped relative to each other such that the engagement between these two surfaces does not resist relative movement between the handle portions 12, 14 to move the hand tool from the closed position to the open position. Instead, the second protrusion 342 can function as a cam surface that causes the latch arm 320 to move from the unlocked position (FIG. 20A) to the locked position (FIG. 20B) (without applying any manual force directly to the latch arm) when the user performs a maneuver to open the hand tool (such as moving the handle portions away from each other). In particular, to the open hand tool, the handle portions 12, 14 are initially pivoted away from each other to increase angle A (FIG. 7), which causes the latch arm 320 to pivot toward the locked position via engagement of the protrusions 342 with surface 350b until the ball is moved past the ridge 338, at which point the latch arm 320 becomes biased toward the first protrusion 340. In this position, the tool elements 26, 32 are partially open, as depicted in FIG. 7. The handle portions 12, 14 then pivot back toward each other (decreasing angle A), further pivoting the tool elements 26, 32 to the fully open position shown in FIGS. 18 and 19.

In some examples, in the fully open position of the hand tool 310, the latch arm 320 may engage the first protrusion 340 to resist inadvertent closure of the hand tool during use. Nonetheless, a separate locking mechanism 362 can be used to lock the hand tool 310 in the open position, as further described below.

In the above example, the latch arm 320 and the detent surfaces 336a and 336b are attached to or part of the second handle portion 14, while the first and second protrusions 340 and 342 are located on the first handle portion 12. However, in other examples, the position of these components can be reversed. In other words, the latch arm 320 and the detent surfaces 336a and 336b may be attached to or part of the first handle portion 12, while the first and second protrusions 340 and 342 can be located on the second handle portion 14.

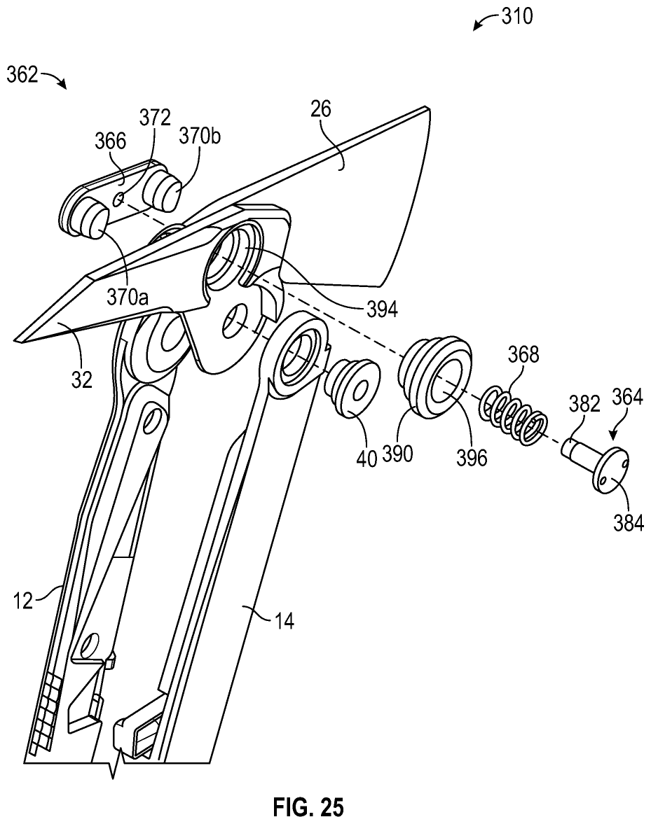

As noted above, the hand tool 310 can further comprise a locking mechanism 362 configured to retain the tool elements 26, 32 in an open configuration (FIGS. 18 and 19). In this example, the locking mechanism 362 can comprise a bolt 364 comprising a head 384, a locking bar 366, and a spring 368 (shown in FIGS. 25, 26, and 28).

As shown in FIGS. 25-28, the locking bar 366 can comprise one or more lock projections 370a and 370b and a bolt socket 372. The one or more lock projections 370a and 370b extend through one or more corresponding lock apertures 374 in the first tool element 26 and can be configured to align with one or more corresponding sockets 376a and 376b (as illustrated in FIG. 28) in the second tool element 32 when the hand tool 310 is in the open configuration. In some examples, the locking bar 366 can be disposed within a recess 378 in the first tool element 26 such that the locking bar 366 remains flush with the outer surface of the tool element 26.

In some examples, as illustrated in FIGS. 25-28, the locking bar 366 comprises two lock projections 370a and 370b extending through two lock apertures 374 in the first tool element 26 and aligned with two corresponding sockets 376a and 376b in the second tool element 32 when the collapsible hand tool 310 is in the open configuration. The two lock projections 370a and 370b of this example each comprise one flattened side 374a and 374b extending at least partially along the height of the projection from their tips, as best shown in FIG. 27. The remainder of the height of each locking projection can be fully cylindrical and is denoted by surfaces 380a and 380b. The two corresponding sockets 376a and 376b in the second tool element 32 have corresponding flattened sides 392a and 392b matching the profile of the flattened sides of the lock projections, thereby keying the orientation of the projections to a specific orientation in the sockets of the second tool element 32. Therefore, only when the sockets 376a and 376b of the second tool element 32 are in the same angular orientation as the locking protrusions 370a and 370b will the projections 370a, 370b extend into the sockets 376a, 376b.

As best shown in FIGS. 25, 26, and 28, the bolt 364 (which can be referred to as a push button or actuator for actuating the locking mechanism 362) extends through a bore 396 in a pivot element 390 and through both the first tool element 26 and an opening 394 in the second tool element 32. An end portion 382 of the bolt 364 extends into the bolt socket 372 of the locking bar 366 to secure the bolt 364 to the locking bar 366. For example, the end portion 382 can be threaded and tightened into an internally threaded bolt socket 372. A head portion 384 of the bolt 364 is disposed within the bore 396 or may protrude slightly laterally out of the bore 396. The spring 368 is disposed within the bore 396 of the pivot element 390 and is captured between the head portion 384 of the bolt 364 and an adjacent surface of the pivot element 390 or the first tool element 26.

The pivot element 390 is the fourth pivot element of the hand tool 310 (which also includes first, second, and third pivot elements 24, 38, and 40, respectively). The pivot element 390 extends through the opening 394 of the second tool element 32 and is secured to the first tool element 26. For example, the pivot element 390 can have a threaded outer surface and the first tool element 26 can have an opening 398 having corresponding internal threads such that the pivot element 390 can be tightened into the opening 398. This allows the tool elements 26, 32 to rotate relative to each other about a pivot axis defined by the pivot element 390.

When the hand tool 310 is in the fully open configuration, the lock projections 370a and 370b of the locking bar 366 align with the corresponding sockets 376a and 376b in the second tool element 32. The spring 368 urges the bolt 364 laterally outwards relative to the second tool element 32, and the bolt 364 pulls the locking bar 366 laterally inwards toward the first tool element 26. This causes the lock projections 370a and 370b to extend into the corresponding sockets 376a and 376b and prevents the first tool element 26 and the second tool element 32 from rotating relative to one another while the locking mechanism 362 is engaged, which retains the hand tool 310 in the open configuration. As previously described, only when the angular orientation of the flattened surfaces 374a and 374b of the lock projections match the angular orientation of the flattened surfaces 392a and 392b of the sockets will the mechanism engage, thereby preventing locking before full alignment.

To return the collapsible hand tool 310 to the closed configuration, the head portion 384 of the bolt 364 can be pressed laterally inwards toward the second tool element 32. This moves the locking bar 366 laterally outwards relative to the first tool element 26 and causes the lock projections 370a and 370b to exit the corresponding sockets 376a and 376b. Thereafter, the first tool element 26 and the second tool element 32 can be rotated relative to one another, and inwards relative to the handle portions 12, 14 to return the collapsible hand tool 310 to the closed configuration.

The lock projections 370a, 370b can reside within the apertures 374 of the second tool element 26 and the locking bar 366 can reside within the recess 378 when the hand tool is in the open or closed configurations (or any position therebetween). However, in some examples, when the hand tool is in the closed configuration, the lock projections 370a, 370b can be prevented from extending into the sockets 376a, 376b by virtue of the flattened surfaces 374a and 374b of the lock projections being at a different rotational orientation than the flattened surfaces 392a and 392b of the sockets such that the locking mechanism 362 does not lock the hand tool in the closed configuration. Thus, in such examples, the user need not actuate the locking mechanism 362 to open the hand tool 310. When the hand tool is transitioned from the closed configuration to the open configuration, the lock projections 370a, 370b become rotational aligned with the sockets 376a, 376b, causing the lock projections 370a, 370b to move into the sockets 376a, 376b under the biasing force of the spring 368.

In other examples, the lock projections 370a, 370b and the sockets 376a, 376b can have other non-circular cross-sectional profiles that permit the lock projections 370a, 370b to extend into the sockets 376a, 376b only when hand tool reaches the open position and the lock projections 370a, 370b become rotationally aligned with the sockets 376a, 376b. For example, each of the lock projections 370a, 370b and the sockets 376a, 376b can have a cross-sectional profile that is square, rectangular, oval, etc.

While FIG. 28 depicts a locking mechanism 362 with the locking bar 366 positioned in a recess 378 in the first tool element 26, and with lock projections 370a and 370b extending into corresponding sockets in the second tool element 32, it will be appreciated that, in some examples, the position of these components can be reversed. That is, the locking bar 366 can be disposed in a recess 378 in the second tool element 32 and the lock projections 370a and 370b can extend through the apertures 374 in the second tool element 32 and into corresponding sockets 376a and 376b in the first tool element 26.

In some examples, as best shown in FIG. 20A, the first pivot element 24 can have an opening 400 that extends completely through the pivot element and both handle portions 12, 14. This allows for a convenient way to connect the hand tool 310 to a belt loop, tool belt, or some other device, such as with a carabiner clip or a ring that is placed through the opening 400.

In some examples, one or both of the latch mechanism 318 and the locking mechanism 362 can be incorporated in the hand tool 10.

In some examples, the hand tool 10 or 310 may not include any locking mechanism 62, 362 or latch mechanism 318. In such examples, squeezing the handle portions 12, 14 together may be sufficient to resist closure of the tool elements against impact loads during use. Moreover, in some examples, the hand tool 10, 310 can include a biasing element such as spring configured to bias the hand tool to the open position. The biasing force of the biasing element can assist in retaining the hand tool in the open position during use (with or without a locking mechanism).

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A hand tool comprising a first handle portion comprising a first end portion and a second end portion; a second handle portion comprising a first end portion and a second end portion; a first tool element; and a second tool element; wherein the first end portion of the first handle portion is rotatably coupled to the first end portion of the second handle portion at a first pivot axis; wherein the second end portion of the first handle portion is rotatably coupled to the first tool element at a second pivot axis; wherein the second end portion of the second handle portion is rotatably coupled to the second tool element at a third pivot axis; and wherein the first tool element is rotatably coupled to the second tool element at a fourth pivot axis; wherein the hand tool is movable from a closed configuration to an open configuration.

Example 2. The hand tool of any example herein, particularly example 1, wherein the first tool element and the second tool element are portions of an axe.

Example 3. The hand tool of any example herein, particularly example 1, wherein the first tool element and the second tool element are portions of a hammer.

Example 4. The hand tool of any example herein, particularly example 1, wherein the first tool element and the second tool element are portions of a pick.

Example 5. The hand tool of any example herein, particularly example 1, wherein when the hand tool is in the closed configuration, the first tool element extends substantially parallel to the first handle portion and the second tool element extends substantially parallel to the second handle portion.

Example 6. The hand tool of any example herein, particularly example 1, wherein when the hand tool is in the open configuration, the first tool element extends substantially perpendicular to the first handle portion and the second tool element extends substantially perpendicular to the second handle portion.

Example 7. The hand tool of any example herein, particularly example 1, wherein the first handle portion comprises a recess, and the recess receives a portion of the first tool element when the hand tool is in the closed configuration.

Example 8. The hand tool of any example herein, particularly example 7, wherein when the hand tool is in the closed configuration, a portion of the first tool element is disposed between the first handle portion and the second handle portion.

Example 9. The hand tool of any example herein, particularly example 1, wherein the first handle portion and the second handle portion are spaced rotationally apart by a first angle when the hand tool is in the closed configuration, the first handle portion and the second handle portion are spaced rotationally apart by a second angle when the hand tool is in the open configuration, and the first angle is greater than the second angle.

Example 10. The hand tool of any example herein, particularly example 1, further comprising a locking mechanism configured to retain the hand tool in the open configuration.

Example 11. The hand tool of any example herein, particularly example 10, wherein the locking mechanism comprises one or more lock projections that extend through corresponding openings in the first tool element and into one or more corresponding sockets in the second tool element when the hand tool is in the open configuration, and wherein the lock projections are removable from the sockets to permit moving the hand tool from the open configuration to the closed configuration.

Example 12. The hand tool of any example herein, particularly example 11, wherein the locking mechanism comprises a locking bar and the one or more lock projections comprise two lock projections extending from the locking bar.

Example 13. The hand tool of any example herein, particularly example 11, wherein the fourth pivot axis extends through the locking mechanism.

Example 14. The hand tool of any example herein, particularly example 1, further comprising a latch mechanism configured to retain the hand tool in the closed configuration.

Example 15. The handle tool of any example herein, particularly example 14, wherein the latch mechanism comprises a latch arm pivotably connected to the second handle portion, wherein the latch mechanism is configured to pivot between a locked position and an unlocked position, wherein when the latch arm is in the locked position, the latch arm engages a locking element on the first handle portion to resist pivoting movement of the first and second handle portions relative to each other, and wherein when the latch arm is in the unlocked position, the latch arm is spaced from the locking element to permit pivoting movement of the first and second handle portions relative to each other.

Example 16. The hand tool of any example herein, particularly example 15, wherein the latch mechanism comprises first and second detent surfaces on the first handle portion, wherein when the latch arm is juxtaposed to the first detent surface, the latch arm is biased toward the locked position, and wherein when the latch arm is juxtaposed to the second detent surface, the latch arm is biased toward the unlocked position.

Example 17. The hand tool of any example herein, particularly example 16, wherein the latch mechanism comprises a spring housed within the latch arm and a detent ball extending from the latch arm, wherein the spring urges the detent ball against the first and second detent surfaces when the latch arm is pivoted between the locked and unlocked positions.

Example 18. The hand tool of any example herein, particularly example 1, further comprising a spring clip and wherein the first handle portion comprises a recess, wherein the spring clip is disposed in the recess.

Example 19. The hand tool of any example herein, particularly example 18, wherein the spring clip has a deflected state and a non-deflected state, and wherein when the spring clip is in the non-deflected state, the spring clip does not extend laterally outside of the recess.

Example 20. A hand tool comprising first and second handle portions rotatably coupled to each other at a first pivot axis; a first tool element rotatably coupled to the first handle portion at a second pivot axis; a second tool element rotatably coupled to the second handle portion at a third pivot axis; wherein the first and second tool elements are rotatably coupled to each other at a fourth pivot axis; and wherein the hand tool is configured to transition from a storage position to a use position by rotating the first and second handle portions relative to each other about the first pivot axis, rotating the first tool element relative to the first handle portion about the second pivot axis, rotating the second tool element relative to the second handle portion about the third pivot axis, and rotating the first and second tool elements relative to each other about the fourth pivot axis.

Example 21. The hand tool of any example herein, particularly example 20, wherein when the hand tool is in the storage position, the first tool element extends substantially parallel to the first handle portion and the second tool element extends substantially parallel to the second handle portion.

Example 22. The hand tool of any example herein, particularly example 21, wherein when the hand tool is in the use position, the first tool element extends substantially perpendicular to the first handle portion and the second tool element extends substantially perpendicular to the second handle portion.

Example 23. The hand tool of any example herein, particularly example 20, wherein the first and second tool elements are portions of an axe.

Example 24. The hand tool of any example herein, particularly example 20, further comprising a locking mechanism comprising one or more lock projections that extend through corresponding openings in the first tool element and into one or more corresponding sockets in the second tool element when the hand tool is in the use position, and wherein the lock projections are removable from the sockets to permit the hand tool to transition from the use position to the storage position.

Example 25. The hand tool of any example herein, particularly example 20, further comprising a latch mechanism configured to retain the hand tool in the storage position.

Example 26. A hand tool comprising a handle having a recess and a ledge extending within the recess; a spring clip disposed in the recess and comprising a first end portion, a second end portion, a first leg, and a second leg joined to the first leg at the first end portion of the spring clip, the first leg and the second leg defining an opening; wherein the ledge extends into the opening between the first leg and the second leg; wherein pressing on the first end portion of the spring clip causes the opening between the first leg and the second leg to widen at the second end portion to move the spring clip from a non-deflected state to a deflected state; and wherein when the spring clip is in the non-deflected state, the first leg and the second leg do not extend outside of the recess.

Example 27. The hand tool of any example herein, particularly example 26, wherein the spring clip comprises a projection and the ledge comprises an aperture to receive the projection.

Example 28. The hand tool of any example herein, particularly example 26, wherein when the spring clip is in the deflected state, the opening between the first leg and the second leg is configured to receive a portion of a garment between the first leg and the ledge.

Example 29. The hand tool of any example herein, particularly example 28, wherein when the portion of the garment is received between the first leg and the ledge, the resiliency of the spring clip retains the garment against the ledge.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A hand tool comprising:
a first handle portion comprising a first end portion and a second end portion;
a second handle portion comprising a first end portion and a second end portion;
a first tool element;
a second tool element;
wherein the first end portion of the first handle portion is rotatably coupled to the first end portion of the second handle portion at a first pivot axis;
wherein the second end portion of the first handle portion is rotatably coupled to the first tool element at a second pivot axis;
wherein the second end portion of the second handle portion is rotatably coupled to the second tool element at a third pivot axis; and
wherein the first tool element is rotatably coupled to the second tool element at a fourth pivot axis;
wherein the hand tool is movable from a closed configuration to an open configuration.

2. The hand tool of claim 1, wherein the first tool element and the second tool element are portions of an axe.

3. The hand tool of claim 1, wherein when the hand tool is in the closed configuration, the first tool element extends substantially parallel to the first handle portion and the second tool element extends substantially parallel to the second handle portion.

4. The hand tool of claim 1, wherein when the hand tool is in the open configuration, the first tool element extends substantially perpendicular to the first handle portion and the second tool element extends substantially perpendicular to the second handle portion.

5. The hand tool of claim 1, wherein the first handle portion comprises a recess, and the recess receives a portion of the first tool element when the hand tool is in the closed configuration.

6. The hand tool of claim 5, wherein when the hand tool is in the closed configuration, a portion of the first tool element is disposed between the first handle portion and the second handle portion.

7. The hand tool of claim 1, wherein the first handle portion and the second handle portion are spaced rotationally apart by a first angle when the hand tool is in the closed configuration, the first handle portion and the second handle portion are spaced rotationally apart by a second angle when the hand tool is in the open configuration, and the first angle is greater than the second angle.

8. The hand tool of claim 1, further comprising a locking mechanism configured to retain the hand tool in the open configuration.

9. The hand tool of claim 8, wherein the locking mechanism comprises one or more lock projections that extend through corresponding openings in the first tool element and into one or more corresponding sockets in the second tool element when the hand tool is in the open configuration, and wherein the lock projections are removable from the sockets to permit moving the hand tool from the open configuration to the closed configuration.

10. The hand tool of claim 9, wherein the locking mechanism comprises a locking bar and the one or more lock projections comprise two lock projections extending from the locking bar.

11. The hand tool of claim 9, wherein the fourth pivot axis extends through the locking mechanism.

12. The hand tool of claim 1, further comprising a latch mechanism configured to retain the hand tool in the closed configuration.

13. The handle tool of claim 12, wherein the latch mechanism comprises a latch arm pivotably connected to the second handle portion, wherein the latch mechanism is configured to pivot between a locked position and an unlocked position, wherein when the latch arm is in the locked position, the latch arm engages a locking element on the first handle portion to resist pivoting movement of the first and second handle portions relative to each other, and wherein when the latch arm is in the unlocked position, the latch arm is spaced from the locking element to permit pivoting movement of the first and second handle portions relative to each other.

14. The hand tool of claim 13, wherein the latch mechanism comprises first and second detent surfaces on the first handle portion, wherein when the latch arm is juxtaposed to the first detent surface, the latch arm is biased toward the locked position, and wherein when the latch arm is juxtaposed to the second detent surface, the latch arm is biased toward the unlocked position.

15. The hand tool of claim 14, wherein the latch mechanism comprises a spring housed within the latch arm and a detent ball extending from the latch arm, wherein the spring urges the detent ball against the first and second detent surfaces when the latch arm is pivoted between the locked and unlocked positions.

16. The hand tool of claim 1, further comprising a spring clip and wherein the first handle portion comprises a recess, wherein the spring clip is disposed in the recess, wherein the spring clip has a deflected state and a non-deflected state, and wherein when the spring clip is in the non-deflected state, the spring clip does not extend laterally outside of the recess.

17. A hand tool comprising:
first and second handle portions rotatably coupled to each other at a first pivot axis;
a first tool element rotatably coupled to the first handle portion at a second pivot axis;
a second tool element rotatably coupled to the second handle portion at a third pivot axis;
wherein the first and second tool elements are rotatably coupled to each other at a fourth pivot axis; and
wherein the hand tool is configured to transition from a storage position to a use position by rotating the first and second handle portions relative to each other about the first pivot axis, rotating the first tool element relative to the first handle portion about the second pivot axis, rotating the second tool element relative to the second handle portion about the third pivot axis, and rotating the first and second tool elements relative to each other about the fourth pivot axis.

18. The hand tool of claim 17, wherein when the hand tool is in the storage position, the first tool element extends substantially parallel to the first handle portion and the second tool element extends substantially parallel to the second handle portion, and wherein when the hand tool is in the use position, the first tool element extends substantially perpendicular to the first handle portion and the second tool element extends substantially perpendicular to the second handle portion.

19. The hand tool of claim 17, wherein the first and second tool elements are portions of an axe.

20. The hand tool of claim 17, further comprising a locking mechanism comprising one or more lock projections that extend through corresponding openings in the first tool element and into one or more corresponding sockets in the second tool element when the hand tool is in the use position, and wherein the lock projections are removable from the sockets to permit the hand tool to transition from the use position to the storage position.

21. The hand tool of claim 17, further comprising a latch mechanism configured to retain the hand tool in the storage position.

22. A hand tool comprising:
a handle having a recess and a ledge extending within the recess;
a spring clip disposed in the recess and comprising a first end portion, a second end portion, a first leg, and a second leg joined to the first leg at the first end portion of the spring clip, the first leg and the second leg defining an opening;
wherein the ledge extends into the opening between the first leg and the second leg;
wherein pressing on the first end portion of the spring clip causes the opening between the first leg and the second leg to widen at the second end portion to move the spring clip from a non-deflected state to a deflected state; and
wherein when the spring clip is in the non-deflected state, the first leg and the second leg do not extend outside of the recess.
